(19) United States
(12) Patent Application Publication
(10) Pub. No.: US 2012/0287355 A1
(43) Pub. Date: Nov. 15, 2012

(54) LIGHTING DEVICE, DISPLAY DEVICE, AND TELEVISION RECEIVER

(75) Inventor: Tomoaki Oya, Osaka-shi (JP)

(73) Assignee: SHARP KABUSHIKI KAISHA, Osaka-shi, Osaka (JP)

(21) Appl. No.: 13/574,332

(22) PCT Filed: Jan. 11, 2011
(86) PCT No.: PCT/JP2011/050250

§ 371 Date: Jul. 20, 2012

(30) Foreign Application Priority Data
Feb. 2, 2010 (JP) 2010-021119

(51) Int. Cl. F21V 8/00; H04N 3/10; G02F 1/13357

(52) U.S. Cl. 348/790; 362/609; 349/65; 348/E03.011

(57) ABSTRACT

It is an object of the present invention to provide a lighting device with improved light use efficiency. A lighting device according to the present invention includes: LEDs 22 with a light emitting surface 22A; a light guide plate 50 with a light entrance surface 50D and a light exit surface 50A; a light guide plate-side light reflection sheet 30 covering a surface 50B of the light guide plate 50 on a side opposite to the light exit surface 50A and reflecting light toward the light exit surface 50A of the light guide plate 50; a back-side light reflection sheet 60 covering the LEDs 22 from a side of the light guide plate 50 opposite to the light exit surface 50A and reflecting light from the light emitting surface 22A toward the light entrance surface 50D of the light guide plate 50; and a front-side light reflection sheet 70 covering the LEDs 22 from the side of the light exit surface 50A of the light guide plate 50 and reflecting the light from the light emitting surface 22A toward the light entrance surface 50D of the light guide plate 50. The back-side light reflection sheet 60 has an end portion 60D on the side of the light guide plate 50 with overlapping with an end portion 30A of the light guide plate-side light reflection sheet 30 on the side of the LEDs 22 in plan view.

### TECHNICAL FIELD

The present invention relates to a lighting device, a display device, and a television receiver.

### BACKGROUND ART

In recent years, flat display elements such as a liquid crystal panel and a plasma display panel have been used as display elements for image display devices, providing a flat image display device. When a liquid crystal panel is used as a display element, a lighting device (backlight unit) is additionally required because the liquid crystal panel does not emit light by itself.

One example of such a lighting device is described in Patent Document 1 indicated below. The lighting device includes a light source (such as an LED) disposed at a side end portion (side edge) of the lighting device, and a light guide plate directing light from the light source toward a display surface of the liquid crystal panel. The light source is opposed to a light entrance surface of the light guide plate. The light that has entered via the light entrance surface is guided as it is repeatedly totally reflected within the light guide plate until the light exits through a light exit surface.
Patent Document 1: Japanese Unexamined Patent Publication No. 2005-302485

### Problem to be Solved by the Invention

In the configuration with the light guide plate as described above, it is important to ensure the light from the light source to enter through the light entrance surface more reliably, thereby to increase the light use efficiency. Generally, the light emitted by a light source such as an LED spreads radially from the optical axis of the light source. Thus, the light increasingly spreads with larger distance from the light source. Therefore, in order to ensure the light from the light source to enter through the light entrance surface of the light guide plate reliably, it is preferable to direct the optical axis of the light source toward the light entrance surface of the light guide plate and to dispose the light source and the light entrance surface as close to each other as possible. However, it is necessary to provide a certain gap between the light source and the light entrance surface of the light guide plate to prevent interference between the light source and the light guide plate, for example, when the light guide plate is subjected to thermal expansion. Thus, it is difficult to ensure the entire light from the light source to enter through the light entrance surface, and some of the light may fail to enter through the light entrance surface. As a result, the light use efficiency may be decreased.

### DISCLOSURE OF THE PRESENT INVENTION

The present invention has been made in view of the foregoing circumstances, and an object of the present invention is to provide a lighting device with improved light use efficiency.

Another object of the present invention is to provide a display device with such a lighting device, and a television receiver.

### Means for Solving the Problem

In order to solve the above problem, a lighting device according to the present invention includes: a light source with a light emitting surface; a light guide plate opposed to the light emitting surface and including a light entrance surface through which light from the light emitting surface enters, and a light exit surface from which the light exits; a light guide plate-side light reflection member covering a surface of the light guide plate on a side opposite to the light exit surface and reflecting the light from the light emitting surface toward the light exit surface of the light guide plate; a first light source-side light reflection member covering the light source from the side of the light guide plate opposite to the light exit surface, and reflecting the light from the light emitting surface toward the light entrance surface of the light guide plate; and a second light source-side light reflection member covering the light source from the light exit surface side of the light guide plate, and reflecting the light from the light emitting surface toward the light entrance surface of the light guide plate. The first light source-side light reflection member has an end portion on the light guide plate side overlapping an end portion of the light guide plate-side light reflection member on the light source side in plan view.

According to the present invention, the light source is sandwiched between the first light source-side light reflection member on the side of the light guide plate opposite to the light exit surface and the second light source-side light reflection member on the light exit surface side of the light guide plate. Thus, some of the light exiting from the light source reaches the first light source-side light reflection member or the second light source-side light reflection member to be reflected toward the light entrance surface of the light guide plate. Further, the end portion of the first light source-side light reflection member on the light guide plate side overlaps with the end portion of the light guide plate-side light reflection member on the light source side in plan view. In this configuration, the first light source-side light reflection member and the light guide plate-side light reflection member may have no gap therebetween in plan view. Therefore, the light from the light source can be more reliably reflected toward the light entrance surface of the light guide plate. Thus, in the configuration according to the present invention, the light from the light source can more reliably enter the light guide plate, thus increasing the light use efficiency.

In the above configuration, the second light source-side light reflection member may have an end portion on the light guide plate side with overlapping with an end portion of the light guide plate on the light source side in plan view. In this configuration, the second light source-side light reflection member and the light guide plate have no gap therebetween in plan view. Therefore, the light from the light source can be more reliably reflected toward the light entrance surface of the light guide plate.

The first light source-side light reflection member may have an end portion on a side opposite to the light guide plate side, farther away from the light guide plate than an end portion of the light source on a side opposite to the light emitting surface. In this configuration, the light source can be more reliably covered with the first light source-side light reflection member. Therefore, the light can be more reliably reflected toward the light guide plate side.

The second light source-side light reflection member may have an end portion on a side opposite to the light guide plate side, farther away from the light guide plate than an end portion of the light source on a side opposite to the light emitting surface. In this configuration, the light source can be more reliably covered with the second light source-side light reflection member. Therefore, the light can be more reliably reflected toward the light guide plate side.

The lighting device may further include a housing member housing the light source and the light guide plate. The housing member may include a black-colored light absorbing portion opposed to the light source and absorbing light, and the second light source-side light reflection member may be attached to the black-colored light absorbing portion. In this configuration, when the light from the light source reaches the light absorbing portion, for example, via the second light source-side light reflection member, the light is absorbed by the light absorbing portion. Thus, leakage of light to the outside of the lighting device can be prevented.

The light source may be mounted on a light source board, and at least one of the first light source-side light reflection member and the second light source-side light reflection member may be attached to the light source board.

The lighting device may further include a diffuser lens covering the light emitting surface of the light source and diffusing the light from the light emitting surface. In this configuration, the light emitted from the light source is diffused by the diffuser lens. Thus, for the configuration with a plurality of the light sources, for example, the range of irradiation by each of the light sources can be increased by the diffuser lens. As a result, uniform brightness can be obtained while the arrangement interval between the light sources can be increased (i.e., the number of light sources can be decreased). Accordingly, the light with uniform brightness enters through the light incident surface of the light guide plate to reduce uneven brightness in the light exiting from the light exit surface.

When the diffuser lens is provided as in the present invention, the light is widely diffused compared to the configuration without such a diffuser lens. As a result, some of the light may deflect from the light entrance surface of the light guide plate and may fail to enter through the light entrance surface. In this respect, according to the present invention, the first light source-side light reflection member and the second light source-side light reflection member are provided. Therefore, the light deflected from the light entrance surface of the light guide plate can be reflected back to the light guide plate side.

The light source may be a light-emitting diode. By using a light-emitting diode, electric power consumption can be decreased.

In order to solve the problem, a display device according to the present invention includes the lighting device, and a display panel performing a display by utilizing the light from the lighting device.

The display panel may be a liquid crystal panel using liquid crystal. Such a display device can be used as a liquid crystal display device for various purposes, such as a television and a desktop screen of a personal computer, and preferable particularly for a large size screen.

Furthermore, in order to solve the problem, a television receiver according to the present invention includes the display device.

### Advantageous Effect of the Invention

The present invention makes it possible to provide a lighting device with improved light use efficiency, a display device with such a lighting device, and a television receiver.

### BRIEF DESCRIPTION OF THE DRAWINGS

FIG. 1 is an exploded perspective view showing a schematic configuration of a television receiver according to a first embodiment of the present invention;

FIG. 2 is an exploded perspective view showing a schematic configuration of a liquid crystal display device provided in the television receiver of FIG. 1;

FIG. 3 is a cross sectional view showing a cross sectional configuration of the liquid crystal display device of FIG. 2 taken along a short side direction thereof;

FIG. 4 is an exploded perspective view showing a schematic configuration of a liquid crystal display device according to a second embodiment of the present invention;

FIG. 5 is a cross sectional view showing a cross sectional configuration of the liquid crystal display device of FIG. 4 taken along a short side direction thereof; and

FIG. 6 is a cross sectional view showing a cross sectional configuration of a liquid crystal display device according to a third embodiment of the present invention taken along a short side direction thereof.

### BEST MODE FOR CARRYING OUT THE INVENTION

### First Embodiment

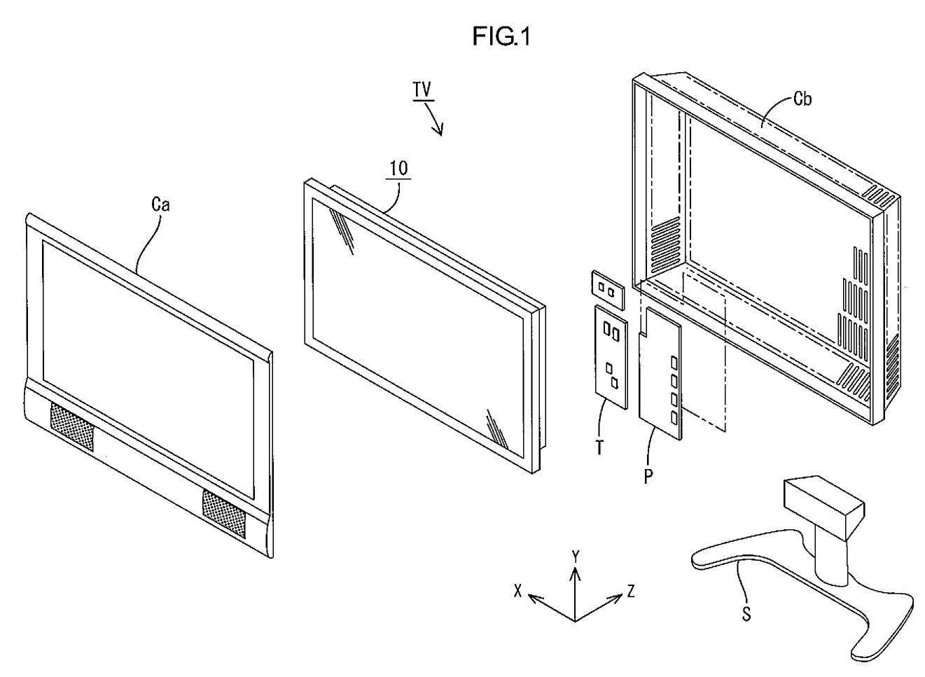

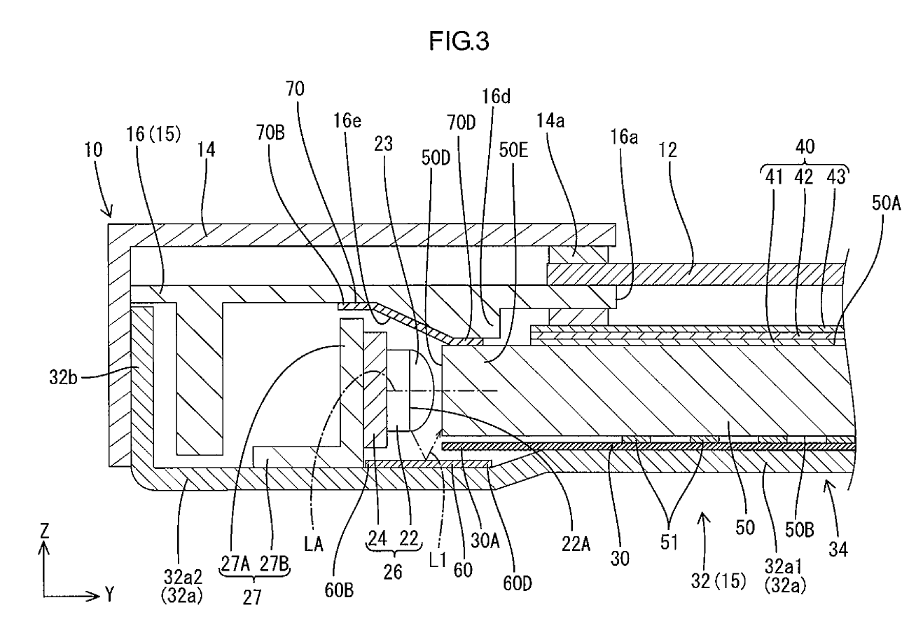

A first embodiment of the present invention will be described with reference to FIGS. 1 to 3. In some of the drawings, an X-axis, a Y-axis, and a Z-axis are shown, with the directions of the respective axes denoting the same directions throughout the drawings. An upper side and a lower side of FIG. 3 correspond to a front side and a back side, respectively.

As shown in FIG. 1, a television receiver TV according to the present embodiment includes: a liquid crystal display device 10; front and rear cabinets Ca and Cb housing the liquid crystal display device 10 in a sandwiching manner; a power source P; a tuner T; and a stand S.

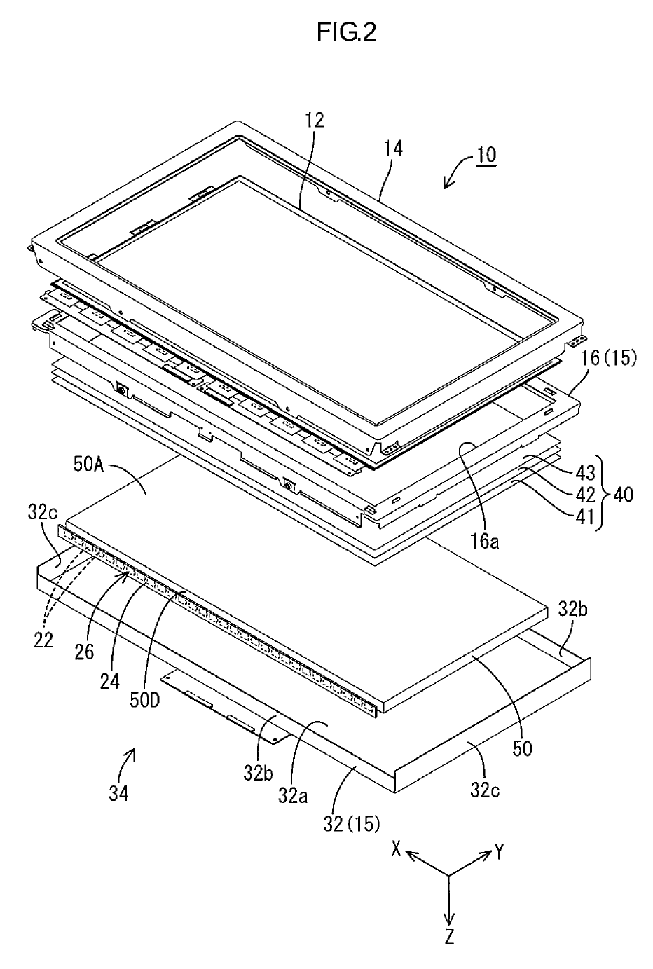

FIG. 2 is an exploded perspective view of the liquid crystal display device 10. As shown in FIG. 2, the liquid crystal display device 10 has a horizontally long square shape as a whole, and includes a liquid crystal panel 12 as a display panel, and a backlight unit 34 as an external light source, which are integrally retained by a frame-shaped bezel 14 and the like.

As shown in FIG. 2, the liquid crystal panel 12 constituting the liquid crystal display device 10 has a rectangular shape in plan view, with a long side direction thereof aligned with a horizontal direction (X-axis direction) and a short side direction aligned thereof with a vertical direction (Y-axis direction). The liquid crystal panel 12 includes a pair of transparent (high light transmissive) glass substrates fixed to each other with a predetermined gap therebetween, in which a liquid crystal layer (not shown) is enclosed.

One of the glass substrates includes switching components (such as TFTs) connected to a source wiring and a gate wiring that are orthogonal to each other, pixel electrodes connected to the switching components, an alignment film, and the like. The other glass substrate includes color filters including color sections of, for example, R (red), G (green), and B (blue) in predetermined arrangements, counter electrodes, an alignment film, and the like. The source wiring, the gate wiring, and the counter electrodes are supplied with image data and various control signals required for displaying an image from a drive circuit board, which is not shown. On the outside of the glass substrates, polarizing plates (not shown) are disposed.

Next, the backlight unit 34 will be described. As shown in FIG. 2, the backlight unit 34 includes a housing member 15. The housing member 15 is constituted by a backlight chassis 32 and a front chassis 16. In the housing member 15, LED unit 26, a light guide plate 50, and an optical member 40 are housed. The backlight unit 34 according to the present embodiment is of a so-called edge light type (side light type), in which the light guide plate 50 is disposed immediately under the liquid crystal panel 12, and the LEDs 22 (Light Emitting Diodes; light sources) are disposed at a side end portion of the light guide plate 50.

The backlight chassis 32 has a substantially box shape with an opening on the front side (light exit side; the side of the liquid crystal panel 12). The optical member 40 covers an opening of the backlight chassis 32. The front chassis 16 has a rectangular frame shape with an opening 16a to expose the optical member 40 on the front side. The front chassis 16 surrounds the optical member 40 in plan view.

As shown in FIG. 3, an inner peripheral end portion of the front chassis 16 is configured to hold a peripheral edge portion of the optical member 40 from the front side via a buffer member 16b. On the front side of an inner peripheral end portion of the front chassis 16, an outer peripheral end portion of the liquid crystal panel 12 is placed. The outer peripheral end portion of the liquid crystal panel 12 is configured to be held by an inner peripheral end portion of the bezel 14 from the front side via a buffer member 14a. Thus, the outer peripheral end portion of the liquid crystal panel 12 is configured to be sandwiched between the inner peripheral end portion of the bezel 14 and the inner peripheral end portion of the front chassis 16. In this way, the light exiting from the light guide plate 50 can be radiated onto the back side of the liquid crystal panel 12 via the optical member 40 and the opening 16a.

The backlight chassis 32, which may be made of a metal such as an aluminum material, includes a bottom plate 32a of a rectangular shape in plan view, and side plates 32b and 32c rising from the outer edges of the bottom plate 32a on both the long sides and short sides thereof toward the front side. The bottom plate 32a has a long side direction aligned with the horizontal direction (X-axis direction) and a short side direction aligned with the vertical direction (Y-axis direction). The LED unit 26 and the light guide plate 50 are disposed on the front side of the bottom plate 32a. As shown in FIG. 3, the bottom plate 32a has one end portion 32a2 in the Y-axis direction with protruding toward the back side relative to a central portion 32a1. The light guide plate 50 is mainly placed on the central portion 32a1 of the bottom plate 32a, while the LED unit 26 is attached to the one end portion 32a2 of the bottom plate 32a. On the back side of the bottom plate 32a, a power source circuit board (not shown) or the like supplying electric power to the LED unit 26 is mounted.

The LED unit 26 is disposed on one end side of the backlight chassis 32 in the short side direction (Y-axis direction). As shown in FIG. 2, the LED unit 26 includes a plurality of white-light emitting LEDs 22 arranged linearly parallel to each other on a LED board 24 of a rectangular shape extending along the X-axis direction.

As shown in FIG. 3, the LEDs 22 have optical axes LA extending along a direction parallel to the display surface of the liquid crystal panel 12 or a light exit surface 50A of the light guide plate 50 (Y-axis direction). The LEDs 22 has a light emitting surface 22A opposed to a side surface (light entrance surface 50D) of the light guide plate 50. The light emitted from the LEDs 22 spreads to some extent three-dimensionally and radially within a predetermined range of angles with respect to the optical axis LA, where the light has a higher directionality than the light from a cold cathode tube, for example. Specifically, the light emission intensity of the LEDs 22 exhibits an angular distribution such that the emission intensity is very high in a direction along the optical axis LA and it sharply decreases as the inclined angle with respect to their optical axes LA increases.

The LEDs 22 include a plurality of LED chips as light emitting elements sealed in a housing with a resin material or the like. The LEDs 22 include three types of LED chips with different dominant emission wavelengths, for example. Specifically, the respective LED chips are configured to emit the single colors of R (red), G (green), and B (blue).

The LED board 24 is made of synthetic resin with a white surface (including a surface opposed to the light guide plate 50) of high light reflectivity, for example. As shown in FIG. 2, the LED board 24 has a rectangular plate shape extending in the X-axis direction. The long side dimension thereof is set to be slightly smaller than (or substantially equal to) a long side dimension of the bottom plate 32a. On the LED board 24, a wiring pattern of a metal film (not shown) is formed. A plurality of the LEDs 22 is mounted on the LED board 24 in electrical connection with the wiring pattern. The LED board 24 is electrically connected with a control board (not shown) to supply electric power required for turning on the LEDs 22 and control the driving of the LEDs 22.

The LED board 24 is attached via an attaching member 27 to the one end portion 32a2 of the bottom plate 32a of the backlight chassis 32. The attaching member 27 extends to the X-axis direction as a whole and includes a side surface portion 27A and a bottom surface portion 27B, forming an L-shaped cross section. The bottom surface portion 27B extends along the bottom plate 32a of the backlight chassis 32, and is attached to the bottom plate 32a with screws or the like, for example. The side surface portion 27A extends along the light entrance surface 50D of the light guide plate 50. The LED board 24 is attached to the side surface portion 27A with screws or the like, for example. The attaching member 27, which is made of a metal with high heat conductivity, has a function of dissipating the heat generated when the LEDs 22 are turned on to the outside of the backlight unit 34 via the bottom plate 32a of the backlight chassis 32. The material of the attaching member 27 is not limited to a metal and may be appropriately changed.

The light emitting surface 22A of the respective LEDs 22 is covered with the diffuser lens 23. The diffuser lens 23 is hemispheric, for example, with the curved surface side opposed to the light entrance surface 50D of the light guide plate 50. This configuration allows the light emitted from the LEDs 22 to be diffused by the diffuser lens 23.

The light guide plate 50 is a plate-like member with a square shape in plan view, and is elongated in the long side direction of the backlight chassis 32 (X-axis direction). The light guide plate 50 is made of high light transmissive (highly transparent) resin, such an acrylic resin. As shown in FIG. 2, the light guide plate 50 has a main plate surface (light exit surface 50A) facing the liquid crystal panel 12 and the side surfaces, one of which (light entrance surface 50D) is opposed to the light emitting surface 22A of the LEDs 22. The light guide plate 50 is not limited to the square shape in plan view, and may have other shapes.

On a surface 50B (back side surface 50B) of the light guide plate 50 opposite to the light exit surface 50A, a plurality of light reflecting portions 51 is formed. The light reflecting portions 51, which are formed by white dot patterns for example, have a function of scattering and reflecting the light. Thus, the light traveling toward the light exit surface 50A after scatter reflection via the light reflecting portions 51 may have an incident angle on the light exit surface 50A not exceeding the critical angle (i.e., light that is not totally reflected). Thus, the light exits from the light exit surface 50A toward the liquid crystal panel 12. The light reflecting portions 51 include a plurality of circular dots in plan view arranged in a zig-zag (or staggered) manner. The dot is formed by printing a paste containing a metal oxide, for example, on the surface 50B on the back side of the light guide plate 50. The dot can be appropriately printed by screen printing, inkjet printing, or the like.

In this configuration, the light exiting from the light emitting surface 22A of the LEDs 22 is diffused by the diffuser lens 22 to enter the light guide plate 50 via the light entrance surface 50D thereof. The light that has entered the light guide plate 50 via the light entrance surface 50D is guided within the light guide plate 50 by total reflection and scattered and reflected by the light reflecting portions 51 to exit from the light output surface 50A. The light that has exited from the light exit surface 50A is radiated onto the back surface side of the liquid crystal panel 12 through the optical member 40. The light reflecting portions 51 are formed in the corresponding area to the opening 16a of the front chassis 16 (i.e., the overlapping area with the opening 16a in plan view), for example.

The optical member 40 covers the light exit surface 50A of the light guide plate 50 from the front side. The optical member 40 includes a light diffuser sheet 41, a prism sheet 42, and a reflection type polarizing sheet 43 with stacked in order from the side of the light exit surface 50A. The light diffuser sheet 41 includes, for example, a light transmissive base substrate of synthetic resin with a diffuser layer fixed thereto, in which light scattering particles are dispersed. Thus, the light diffuser sheet 41 has a function of diffusing the light exiting from the light exit surface 50A. The prism sheet 42 has a function of adjusting the travel direction of the light that has passed through the light diffuser sheet 41.

The reflection type polarizing sheet 43, which has a multilayer structure of layers with different refractive index alternately stacked upon one another, is configured to transmit P wave of the light exiting from the light exit surface 50A, and reflect S wave of the light toward the light guide plate 50. The S wave reflected by the reflection type polarizing sheet 43 is reflected back toward the front side by a light guide plate-side light reflection sheet 30 (to be described below) or the like, where the light is separated into the S wave and the P wave. Thus, the reflection type polarizing sheet 43 makes it possible to re-utilize the S wave that is normally absorbed by the polarizing plate of the liquid crystal panel 12. Therefore the light use efficiency (and further brightness) can be increased. One example of the reflection type polarizing sheet 43 is the product such as “DBEF” manufactured by Sumitomo 3M Limited.

As shown in FIG. 2, the light diffuser sheet 41, the prism sheet 42, and the reflection type polarizing sheet 43 have an elongated square shape in the X-axis direction in plan view, similar to the shape of the light guide plate 50. The light diffuser sheet 41, the prism sheet 42, and the reflection type polarizing sheet 43 each have substantially the same area as that of the light exit surface 50A of the light guide plate 50 to cover substantially the entire area of the light exit surface 50A of the light guide plate 50 from the front side. The shape of the sheets 41 to 43 constituting the optical member 40 is not limited to square in plan view and may be other shapes.

The light guide plate-side light reflection sheet 30 (light guide plate-side light reflection member) is laid on the bottom plate 32a of the backlight chassis 32. The light guide plate-side light reflection sheet 30 has a square shape in plan view and covers substantially the entire area of the surface 50B on the back side of the light guide plate 50 (i.e., the surface of the light guide plate opposite to the light exit surface) from the back side. The light guide plate-side light reflection sheet 30 is made of synthetic resin with a white surface having excellent optical reflectivity, for example. With the light guide plate-side light reflection sheet 30, the light that has exited from the light guide plate 50 toward the light guide plate-side light reflection sheet 30 can be reflected back toward the light exit surface 50A, thus increasing the light use efficiency.

Further, in the backlight unit 34 according to the present embodiment, a back-side light reflection sheet 60 (first light source-side light reflection member) and a front-side light reflection sheet 70 (second light source-side light reflection member) sandwich the LED unit 26 from the front and back sides. The back-side light reflection sheet 60 is placed on the front side of the one end portion 32a2 of the bottom plate 32a of the backlight chassis 32. The back-side light reflection sheet 60 has an elongated square shape in the X-axis to cover the plurality of LEDs 22 from the side of the light guide plate 50 opposite to the light exit surface 50A. The back-side light reflection sheet 60 is made of synthetic resin with a white surface of excellent optical reflectivity, for example. The back-side light reflection sheet 60 is configured to reflect some of the light traveling from the light emitting surface 22A of the LEDs 22 toward the light guide plate 50, which has reached the back-side light reflection sheet 60, toward the light entrance surface 50D of the light guide plate 50 through which the light enters.

An end portion 60D of the back-side light reflection sheet 60 on the side of the light guide plate 50 overlaps with an end portion 30A of the light guide plate-side light reflection sheet 30 on the side of the LEDs 22 in plan view. More specifically, while the light guide plate 50 is mainly placed on the central portion 32a1 of the bottom plate 32a as described above, an end portion 50E of the light guide plate 50 on the side of the LEDs 22 extends over the front side of the one end portion 32a2 of the bottom plate 32a. Thus, the light guide plate 50 (or the light guide plate-side light reflection sheet 30) and the one end portion 32a2 of the bottom plate 32a have a gap extending in the X-axis direction therebetween. The end portion 60D of the back-side light reflection sheet 60 on the side of the light guide plate 50 is disposed in the gap, thus covering the end portion 30A of the light guide plate-side light reflection sheet 30 on the side of the LEDs 22 from the back side.

On the other hand, an end portion 60B of the back-side light reflection sheet 60 on the side of the LEDs 22 (i.e., the end portion of the first light source-side light reflection member opposite to the light guide plate side) overlaps with the LED board 24 in plan view. In other words, the end portion 60B of the back-side light reflection sheet 60 on the side of the LEDs 22 is disposed farther away from the light guide plate 50 than an end portion of the LEDs 22 opposite to the light emitting surface 22A. Thus, the back-side light reflection sheet 60 is configured to cover the LED unit 26 (and the plurality of the LEDs 22) and the end portion 30A of the light guide plate-side light reflection sheet 30 on the side of the LEDs 22 from the back side.

The front-side light reflection sheet 70 is attached to the back side surface of the front chassis 16. The front chassis 16 includes a protruding portion 16d opposed to the peripheral end portion of the light guide plate 50 and protruding toward the light guide plate 50. A surface of the protruding portion 16d on the side of the LEDs 22 includes an inclined surface which becomes closer to the light guide plate 50 with larger distance from the LEDs 22 in the Y-axis direction (i.e., toward right side in FIG. 3). Most area of the front-side light reflection sheet 70 is disposed along the inclined surface. Namely, the front-side light reflection sheet 70 includes an inclined surface 16e at a central portion in the Y-axis direction, the inclined surface 16e extending along the inclined surface of the protruding portion 16d.

The front-side light reflection sheet 70 has an elongated square shape in the X-axis to cover the plurality of the LEDs 22 from the side of the light exit surface 50A of the light guide plate 50. The front-side light reflection sheet 70 is made of synthetic resin with a white surface of excellent optical reflectivity, for example. The front-side light reflection sheet 70 is configured to reflect some of the light traveling from the light emitting surface 22A of the LEDs 22 toward the light guide plate 50, which has reached the front-side light reflection sheet 70, toward the light entrance surface 50D of the light guide plate 50 through which the light enters.

The front-side light reflection sheet 70 includes an end portion 70D on the side of the light guide plate 50 in a sandwiched manner between the protruding end of the protruding portion 16d of the front chassis 16 and the light exit surface 50A of the light guide plate 50. Thus, the end portion 70D of the front-side light reflection sheet 70 on the side of the light guide plate 50 is disposed in an overlapped manner with respect to the end portion 50E of the light guide plate 50 on the side of the LEDs 22 in plan view.

On the other hand, an end portion 70B of the front-side light reflection sheet 70 on the side of the LEDs 22 (i.e., the end portion of the second light source-side light reflection member opposite to the light guide plate side) overlaps with the LED board 24 and the attaching member 27 in plan view. In other words, the end portion 70B of the front-side light reflection sheet 70 on the side of the LEDs 22 is disposed farther away from the light guide plate 50 than the end portion of the LEDs 22 opposite to the light emitting surface 22A. Thus, the front-side light reflection sheet 70 is configured to cover the LED unit 26 and the end portion 30A of the light guide plate-side light reflection sheet 30 on the side of the LEDs 22 from the front side.

The front chassis 16 on which the front-side light reflection sheet 70 is attached has a black surface with excellent light absorbing property. In this way, the front chassis 16 functions as a light absorbing portion configured to absorb light. In other words, the light absorbing portion is configured to cover the LEDs 22 and the front-side light reflection sheet 70 from the front side. The present embodiment is not limited to the configuration in which front chassis 16 is entirely colored in black. The light absorbing portion may be only a portion of the front chassis 16 opposed to the LEDs 22 (or at which the front-side light reflection sheet 70 is attached) with colored in black.

As shown in FIG. 3, the protruding portion 16d of the front chassis 16 is configured to cover the optical member 40 (or any one of the sheets 41 to 43 constituting the optical member 40) from the side of the LEDs 22. By covering the optical member 40 with the protruding portion 16d from the side of the LEDs 22, the light traveling from the LEDs 22 toward the optical member 40 on the side of the LEDs 22 can be blocked (absorbed) by the protruding portion 16d. Thus, the incident light on the side surface of the optical member 40 can be prevented. When the light enters the sheets 41 to 43 constituting the optical member 40 via the side surface thereof on the side of the LEDs 22, the light may be guided within the sheets 41 to 43 to exit locally from the light exit surface of the backlight unit 34, possibly resulting in uneven brightness. This problem can be reduced by the configuration of the present embodiment by virtue of the protruding portion 16d configured to reduce the light entering through the side surface of the sheets 41 to 43 on the side of the LEDs 22.

Next, the effect of the present embodiment will be described. According to the present embodiment, the back-side light reflection sheet 60 and the front-side light reflection sheet 70 sandwich the LEDs 22 between both sides of the light guide plate 50, i.e., between the light exit surface 50A (front side) and the side (back side) opposite to the light exit surface 50A. Thus, some of the light emitted from the LEDs 22, that has reached the back-side light reflection sheet 60 and the front-side light reflection sheet 70, can be reflected toward the light entrance surface 50D of the light guide plate 50. In FIG. 3, the light reflected by the back-side light reflection sheet 60 toward the light entrance surface 50D of the light guide plate 50 is indicated by an arrow L1.

The end portion 60D of the back-side light reflection sheet 60 on the side of the light guide plate 50 is configured to overlap with the end portion 30A of the light guide plate-side light reflection sheet 30 on the side of the LEDs 22 in plan view. Thus, the back-side light reflection sheet 60 and the light guide plate-side light reflection sheet 30 have no gap therebetween in plan view. Therefore the light from the LEDs 22 can be more reliably reflected toward the light entrance surface 50D of the light guide plate 50. By configuring the back-side light reflection sheet 60 and the light guide plate-side light reflection sheet 30 to partially overlap with each other, the back-side light reflection sheet 60 and the light guide plate-side light reflection sheet 30 have no gap therebetween in plan view even if the back-side light reflection sheet 60 or the light guide plate-side light reflection sheet 30 contracts in the Y-axis direction due to temperature change or the like.

The end portion 70D of the front-side light reflection sheet 70 on the side of the light guide plate 50 overlaps with the end portion 50E of the light guide plate 50 on the side of the LEDs 22 in plan view. Thus, the front-side light reflection sheet 70 and the light guide plate 50 have no gap therebetween in plan view. Therefore, the light from the LEDs 22 can be more reliably reflected toward the light entrance surface of the light guide plate.

The end portion 60B of the back-side light reflection sheet 60 on the side opposite to the light guide plate 50 is farther away from the light guide plate 50 (toward left side in FIG. 3) than the end portion of the LEDs 22 opposite to the light emitting surface 22A. Thus, the LEDs 22 can be more reliably covered with the back-side light reflection sheet 60. Therefore, the light can be more reliably reflected toward the light guide plate 50.

The end portion 70B of the front-side light reflection sheet 70 on the side opposite to the light guide plate 50 is farther away from the light guide plate 50 than the end portion of the LEDs 22 opposite to the light emitting surface 22A. Thus, the LEDs can be more reliably covered with the front-side light reflection sheet 70. Therefore the light can be more reliably reflected toward the light guide plate 50. Accordingly, according to the present embodiment, the light from the LEDs 22 can more reliably enter the light guide plate 50, thereby increasing the light use efficiency.

The LEDs 22 and the light guide plate 50 are housed in the housing member 15, which includes the front chassis 16. The portion of the front chassis 16 opposed to the LEDs 22 is colored in black, thereby constituting the light absorbing portion configured to absorb light. The front-side light reflection sheet is attached to the light absorbing portion. In this configuration, some of the light from the LEDs 22, that reaches the light absorbing portion (front chassis 16) through the front-side light reflection sheet 70, for example, can be absorbed by the light absorbing portion. Thus, the light can be prevented from leaking outside the backlight unit 34.

The diffuser lens 23 covers the light emitting surface 22A of the LEDs 22 and is configured to diffuse the light from the light emitting surface 22A. In this configuration, the light emitted by the LEDs 22 can be diffused by the diffuser lens 23. Thus, the irradiation area by the LEDs 22 can be increased by the diffuser lens 23. Therefore, uniform brightness is obtained while increasing the intervals between the arranged LEDs 22 (i.e., while decreasing the number of the light sources to be decreased). By directing light with uniform brightness to enter the light entrance surface 50D of the light guide plate 50, uneven brightness in the light exiting from the light exit surface 50A can be reduced. When the diffuser lens 23 is provided as in the present embodiment, the light is more widely diffused than when the diffuser lens 23 is not provided. As a result, the light from the LEDs 22 is more likely to deflect from the light entrance surface of the light guide plate 50 (i.e., fail to enter through the light entrance surface). In this respect, in the present embodiment the back-side light reflection sheet 60 and the front-side light reflection sheet 70 are provided. Thus, the light that has deflected from the light entrance surface 50D of the light guide plate 50 can be appropriately reflected by the light reflection sheets 60 and 70 back toward the light guide plate 50.

The LEDs 22 are used as the light sources. The use of the LEDs 22 can reduce electric power consumption.

### Second Embodiment

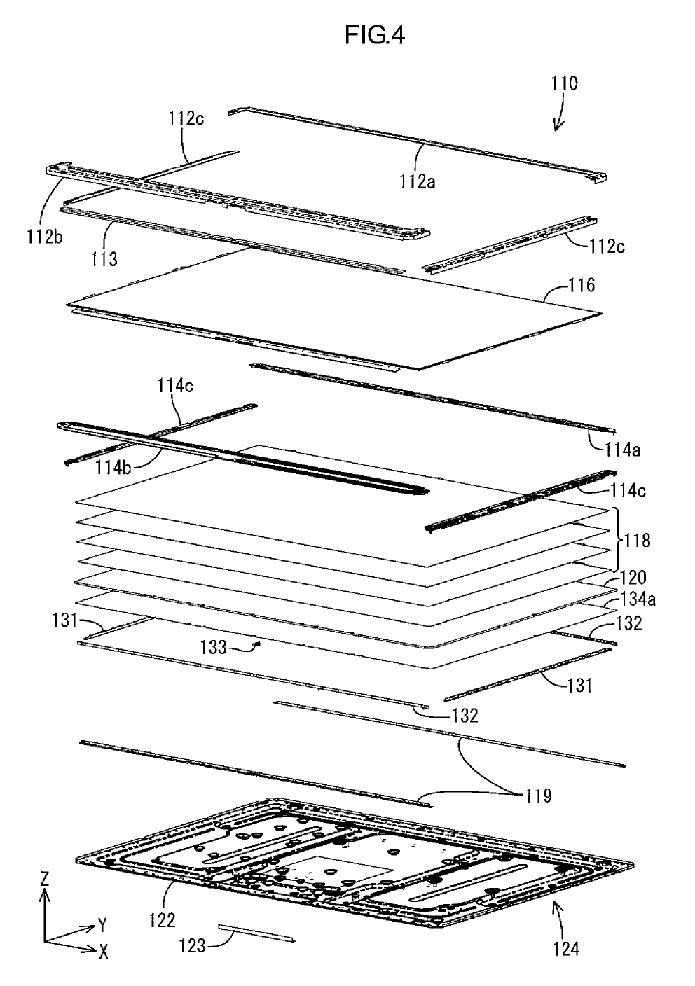

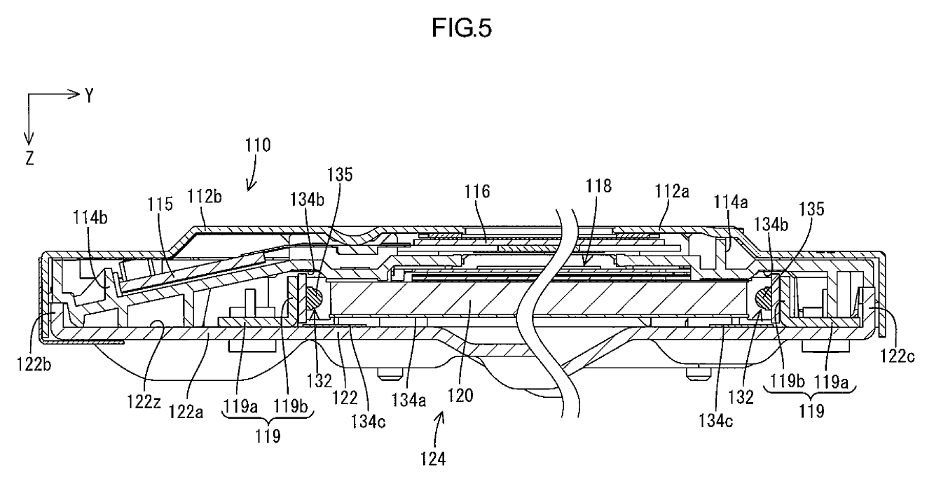

Next, a second embodiment of the present invention will be described with reference to FIG. 4 or 5. According to the second embodiment, a liquid crystal display device 110 has constituent components different from those of the first embodiment. Redundant description of structures, operations, or effects similar to those of the first embodiment will be omitted.

FIG. 4 shows an exploded perspective view of the liquid crystal display device 110 according to the present embodiment. An upper side and a lower side of FIG. 4 correspond to the front side and the back side, respectively. As shown in FIG. 4, the liquid crystal display device 110 has a horizontally long square shape as a whole, and includes a liquid crystal panel 116 as a display panel and a backlight unit 124 as an external light source, which are integrally retained by a top bezel 112a, a bottom bezel 112b, and a side bezel 112c (hereafter referred to as a group of bezels 112a to 112c), and the like. The configuration of the liquid crystal panel 116 is similar to the configuration in the first embodiment; therefore, redundant description will be omitted.

In the following, the backlight unit 124 will be described. The backlight unit 124 according to the present embodiment is of the so-called edge light type (side light type); however, the present embodiment differs from the first embodiment in that LED units 132 are provided on each of side end portions of a light guide plate 120. As shown in FIG. 4, the backlight unit 124 includes a backlight chassis 122, an optical member 118, a top frame 114a, a bottom frame 114b, side frames 114c, and a light guide plate-side light reflection sheet 134a. In the following description, the top frame 114a, the bottom frame 114b, and the side frames 114c will be referred to as a group of frames 114a to 114c.

The liquid crystal panel 116 is sandwiched between the group of the bezels 112a to 112c and the group of the frames 114a to 114c. The reference sign 113 designates an insulating sheet insulating a drive circuit board 115 (see FIG. 5) driving the liquid crystal panel 116. The backlight chassis 122 is opened toward the front side (light exit side; the side of the liquid crystal panel 116), forming a substantially box-like shape with a bottom surface.

The optical member 118 is disposed on the front side of the light guide plate 120. The optical member 118 may be constituted by some appropriately selected among a light diffuser sheet, a prism sheet, a reflection type polarizing sheet, and the like, stacked upon one another. The light guide plate 120, the light guide plate-side light reflection sheet 134a is disposed. The backlight chassis 122 houses a pair of cable holders 131, a pair of attaching members 119, a pair of LED units 132, and the light guide plate 120. The LED units 132, the light guide plate 120, and the light guide plate-side light reflection sheet 134a are supported on one another with a rubber bush 133. On the back surface of the backlight chassis 122, a power source circuit board (not shown) supplying electric power to the LED units 132, a protecting cover 123 protecting the power source circuit board, and the like are attached. The pair of the cable holders 131 is disposed along the short side direction of the backlight chassis 122 and houses wiring electrically connecting the LED units 132 and the power source circuit board.

FIG. 5 shows a horizontal cross sectional view of the backlight unit 124. As shown in FIG. 5, the backlight chassis 122 includes a bottom plate 122a with a bottom surface 122z, and side plates 122b and 122c shallowly rising from outer edges of the bottom plate 122a. The backlight chassis 122 supports at least the LED units 132 and the light guide plate 120.

The pair of the attaching members 119 includes bottom surface portions 119a and side surface portions 119b rising from the outer edge on one of the long sides of the bottom surface portions 119a, forming an L-shaped cross section. The pair of the attaching members 119 is disposed along the direction of the long sides across the backlight chassis 122. The bottom surface portions 119a of the attaching members 119 are fixed on the bottom plate 122a of the backlight chassis 122. The pair of the LED units 132 extends along the direction of the long sides of the backlight chassis 122, and is fixed on the side surface portions 119b of the attaching members 119 such that the light exit sides of respective LED units 132 are opposed to each other. Thus, the pair of the LED units 132 is supported by the bottom plate 122a of the backlight chassis 122 via the attaching members 119. The attaching members 119 also functions as a heat sink, dissipating the heat generated in the LED units 132 to the outside of the backlight unit 124 via the bottom plate 122a of the backlight chassis 122.

As shown in FIG. 5, the light guide plate 120 is disposed between the pair of the LED units 132. The pair of the LED units 132, the light guide plate 120, and the optical member 118 are held between the group of the frames 114a to 114c and the backlight chassis 122. The light guide plate 120 and the optical member 118 are fixed by the group of the frames 114a to 114c and the backlight chassis 122. The configurations of the LED units 132 and the light guide plate 120 are similar to those according to the first embodiment and therefore their redundant description is omitted.

As shown in FIG. 5, the drive circuit board 115 is disposed on the front side of the bottom frame 114b. The drive circuit board 115 is electrically connected to the liquid crystal panel 116 to supply image data required for displaying an image, various control signals, and the like to the liquid crystal panel 116. The top frame 114a and the bottom frame 114b are partially opposed to the LED units 132 (and LEDs 135), where front-side light reflection sheets 134b are disposed along the long side direction of the light guide plate 120. Furthermore, the bottom plate 122a of the backlight chassis 122 is partially opposed to the LED units 132 (and the LEDs 135), where back-side light reflection sheets 134c are disposed. The end portions of the back-side light reflection sheets 134c on the side of the light guide plate 120 overlaps with the end portions of the light guide plate-side light reflection sheet 134a on the side of the LED units 132 in plan view.

### Third Embodiment

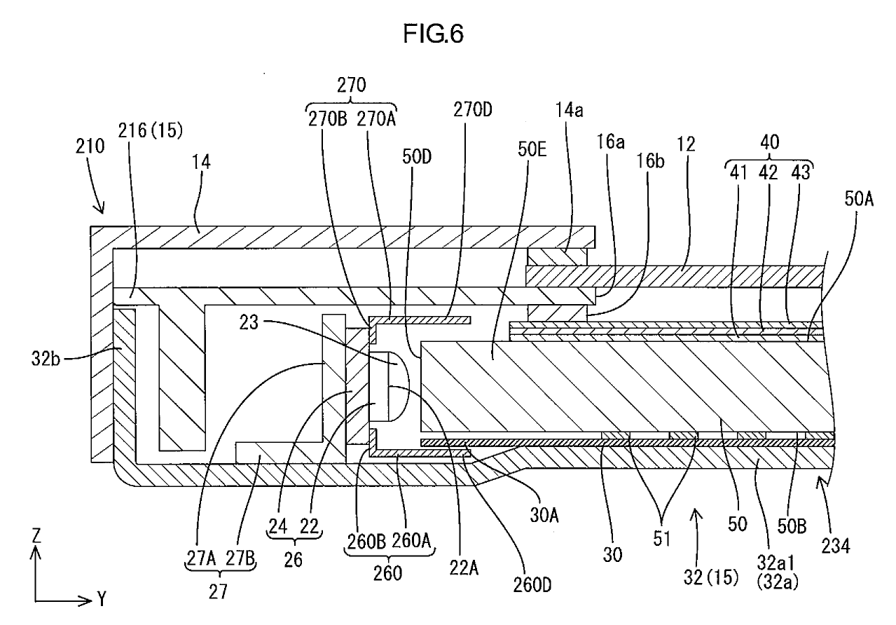

Next, a third embodiment of the present invention will be described with reference to FIG. 6. A backlight unit 234 of a liquid crystal display device 210 according to the present embodiment differs from the one of the first embodiment in the shape and arrangement of a back-side light reflection sheet 260 and a front-side light reflection sheet 270. The back-side light reflection sheet 260 and the front-side light reflection sheet 270 are attached to the LED board 24 (light source board).

The back-side light reflection sheet 260 as a whole extends in the same direction as the LED board 24 (X-axis direction), and includes a planar portion 260A and a side surface portion 260B, forming an L-shaped cross section. The side surface portion 260B is attached to the LED board 24 to extend along the surface thereof (the surface opposed to the light guide plate 50). The planar portion 260A extends along the bottom plate 32a of the backlight chassis 32. An end portion 260D of the planar portion 260A on the side of the light guide plate 50 overlaps with the end portion 30A of the light guide plate-side light reflection sheet 30 on the side of the LEDs 22 in plan view. Thus, the planar portion 260A covers, from the back side, the LEDs 22 and a part of the light guide plate-side light reflection sheet 30.

The front-side light reflection sheet 270 as a whole extends in the same direction as the LED board 24 (X-axis direction), and includes a planar portion 270A and a side surface portion 270B, forming an L-shaped cross section. The side surface portion 270B is attached to the LED board 24 to extend along the surface thereof (including the surface opposed to the light guide plate 50). The planar portion 270A extends along the bottom plate 32a of the backlight chassis 32. An end portion 270D of the planar portion 270A on the side of the light guide plate 50 overlaps with the end portion 50E of the light guide plate 50 on the side of the LEDs 22 in plan view. Thus, the planar portion 270A is configured to cover the LEDs 22 and a part of the light guide plate 50 from the front side. According to the present embodiment, the front chassis 216 is configured to avoid interference between the planar portion 270A and the front chassis 216, without the protruding portion 16d unlike the first embodiment.

### Other Embodiments

The present invention is not limited to the embodiments described by the foregoing description and the drawings, and the following embodiments may be included in the technical scope of the present invention, for example.

(1) The configurations (such as in terms of material, color, or the like) of the light guide plate-side light reflection sheet 30, the back-side light reflection sheets 60, 134c, and 260, and the front-side light reflection sheets 70, 134b, and 270 are not limited to the examples according to the foregoing embodiments and may be modified as long as they have a function of reflecting light.

(2) While according to the third embodiment the back-side light reflection sheet 260 and the front-side light reflection sheet 270 are both attached to the LED board 24, at least one of the back-side light reflection sheet 260 and the front-side light reflection sheet 270 may be attached to the LED board 24.

(3) While according to the foregoing embodiments the LEDs 22 are described as the light sources by way of example, the present invention is not limited to the LEDs and other light sources may be used.

(4) The configuration of the LEDs 22 is not limited to the configuration described according to the foregoing embodiments and other configurations may be used. For example, the LEDs 22 may include a LED chip that emits the single color of B (blue) with covered with resin (such as silicon resin) enclosing phosphors with each emission peak in the R (red) region and in the G (green) region. Alternatively, the LEDs 22 may include a LED chip that emits the single color of B (blue) with covered with resin (such as silicon resin) enclosing a phosphor that emits yellow, such as a YAG phosphor.

(5) While the configurations according to the foregoing embodiments include the LEDs 22 and the diffuser lens 23 (the so-called “dome type” LED), the diffuser lens 23 may not be included.

(6) The shape of the diffuser lens 23 is not limited to the hemispheric shape. The diffuser lens 23 may be in any configuration as long as it diffuses the light from the light source. For example, a cylindrical lens configured to diffuse the light only in a single axial direction may be used.

(7) The configuration of the optical member 40 is not limited to the examples according to the foregoing embodiments. The presence or absence of the respective sheets constituting the optical member 40, the number of each of the sheets used, and the like, may be appropriately modified.

(8) While according to the foregoing embodiments, TFTs are used as the switching components of the liquid crystal display device, the present invention may be also applied to liquid crystal display devices using switching components other than TFT (such as thin-film diode (TFD)). Besides liquid crystal display devices for color display, the present invention may be applied to liquid crystal display devices for monochrome display.

(9) According to the foregoing embodiments, liquid crystal display devices using a liquid crystal panel has been described as the display panel by way of example. However, the present invention may be applied to display devices using other types of display panel.

(10) According to the foregoing embodiments, the television receiver TV with the tuner T has been described by way of example. However, the present invention may be applied to a display device without a tuner.

### EXPLANATION OF SYMBOLS

10, 110, 210: Liquid crystal display device (Display device)
12, 116: Liquid crystal panel (Display panel)
15: Housing member
16, 216: Front chassis (Light absorbing portion)
22, 135: LED (Light source, light-emitting diode)
22A: Light emitting surface
23: Diffuser lens
24: LED board (Light source board)
30, 134a: Light guide plate-side light reflection sheet (Light guide plate-side light reflection member)
30A: End portion of light guide plate-side light reflection sheet on the LED side (End portion of the light guide plate-side light reflection member on the light source side)
34, 124, 234: Backlight unit (Lighting device)
50, 120: Light guide plate
50A: Light exit surface
50B: Surface of light guide plate on the side opposite to light exit surface
50D: Light entrance surface
50E: End portion of light guide plate on the LED side (End portion of light guide plate on the light source side)
60, 134c, 260: Back-side light reflection sheet (First light source-side light reflection member)
60B: End portion of back-side light reflection sheet on the LED side (End portion of first light source-side light reflection member on the side opposite to light guide plate side)
60D: End portion of back-side light reflection sheet on the light guide plate side (End portion of first light source-side light reflection member on the light guide plate side)
70, 134b, 270: Front-side light reflection sheet (Second light source-side light reflection member)
70B: End portion of front-side light reflection sheet on the LED side (End portion of second light source-side light reflection member on the side opposite to the light guide plate side)
70D: End portion of front-side light reflection sheet on the light guide plate side (End portion of second light source-side light reflection member on the light guide plate side)
260D: End portion of planar portion on the light guide plate side (End portion of first light source-side light reflection member on the light guide plate side)
270D: End portion of planar portion on the light guide plate side (End portion of second light source-side light reflection member on the light guide plate side)
TV: Television receiver

1. A lighting device comprising:
a light source with a light emitting surface;
a light guide plate opposed to the light emitting surface and including a light entrance surface through which light from the light emitting surface enters, and a light exit surface from which the light exits;
a light guide plate-side light reflection member covering a surface of the light guide plate on a side opposite to the light exit surface and reflecting the light from the light emitting surface toward the light exit surface of the light guide plate;
a first light source-side light reflection member covering the light source from the side of the light guide plate opposite to the light exit surface, and reflecting the light from the light emitting surface toward the light entrance surface of the light guide plate; and
a second light source-side light reflection member covering the light source from the light exit surface side of the light guide plate, and reflecting the light from the light emitting surface toward the light entrance surface of the light guide plate,
wherein the first light source-side light reflection member has an end portion on the light guide plate side overlapping an end portion of the light guide plate-side light reflection member on the light source side in plan view.

2. The lighting device according to claim 1, wherein the second light source-side light reflection member has an end portion on the light guide plate side overlapping an end portion of the light guide plate on the light source side in plan view.

3. The lighting device according to claim 1, wherein the first light source-side light reflection member has an end portion on a side opposite to the light guide plate side, farther away from the light guide plate than an end portion of the light source on a side opposite to the light emitting surface.

4. The lighting device according to claim 1, wherein the second light source-side light reflection member has an end portion on a side opposite to the light guide plate side, farther away from the light guide plate than an end portion of the light source on a side opposite to the light emitting surface.

5. The lighting device according to claim 1, further comprising a housing member housing the light source and the light guide plate, wherein:
the housing member includes a black-colored light absorbing portion opposed to the light source and absorbing light; and
the second light source-side light reflection member is attached to the black-colored light absorbing portion.

6. The lighting device according to claim 1, wherein:
the light source is mounted on a light source board; and
at least one of the first light source-side light reflection member and the second light source-side light reflection member is attached to the light source board.

7. The lighting device according to claim 1, further comprising a diffuser lens covering the light emitting surface of the light source and diffusing the light from the light emitting surface.

8. The lighting device according to claim 1, wherein the light source is a light-emitting diode.

9. A display device comprising:
the lighting device according to claim 1; and
a display panel performing a display by utilizing the light from the lighting device.

10. The display device according to claim 9, wherein the display panel is a liquid crystal panel using liquid crystal.

11. A television receiver comprising the display device according to claim 9.
